(19) United States
(12) Patent Application Publication
(10) Pub. No.: US 2002/0053635 A1
(43) Pub. Date: May 9, 2002

(54) Arrangement for determining the angle of incidence of light

(75) Inventors: Karin Schroter, Jena (DE); Roland Strietzel, Dresden (DE); Eckehard Strumpf, Jena (DE)

Correspondence Address: WILLIAM COLLARD, COLLARD & ROE, P.C., 1077 NORTHERN BOULEVARD, ROSLYN, NY, 11576, US

(73) Assignee: Jena-Optronik GmbH

(21) Appl. No.: 09/954,894

(22) Filed: Sep. 18, 2001

(30) Foreign Application Priority Data
Sep. 19, 2000 (DE) 100 46 785.7

(51) Int. Cl. G01J 1/20; G01C 21/02

(52) U.S. Cl. 250/203.1

(57) ABSTRACT

An arrangement for determining with high accuracy the angle of incidence of light, in particular sunlight, has low cost electronic components and low susceptibility to sources of interference and other error signals. An elongated photodiode array has a slot for a band of light to illuminate the photodiode array. The slot is arranged with a predefined spacing above and orthogonally to a preset longitudinal direction of the sensor array, which primarily presets the light's maximally detectable angle of incidence. The sensor array includes rows of several aligned congruent photodiode areas having substantially the same length and width. Each photodiode area has a size that generates a maximum photoelectric current when illuminated by the band of light. This current is sufficient in amount to be divided into a selected number and size of digital resolution stages. The light pencil width preset by the slot width is adapted so that portions of light-sensitive photodiode areas overlap each other in the longitudinal direction of the photodiode array despite light insensitive bridges required to electrically insulate neighboring photodiode areas. At least two photodiode areas simultaneously supply at any time a significant photoelectric current from the reproduced band of light.

### BACKGROUND OF THE INVENTION

### CROSS REFERENCE TO RELATED APPLICATIONS

Applicants claim priority under 35 U.S.C. §119 of German Application No. DE 100 46 785.7 filed Sep. 19, 2000.

1. Field of the Invention

The invention relates to an arrangement for determining the angle of incidence of light, in particular of sunlight, by means of an array including a slot and sensors. The invention is primarily used to determine the position and orientation of spacecraft vis-a-vis the sun.

2. The Prior Art

A whole series of so-called sun sensors have become known in the field of space travel for solving the problem of determining the position of spacecraft. One category of sensor determines the angle of incidence by detecting the change in position of a window or slot reproduced on an array of sensors. Among the great variety of sensors, only this category will be discussed below.

U.S. Pat. No. 5,264,691 describes a system for the determination of the direction of the incidence of optical rays, in which a surface sensor is employed. With this system, the sunlight is projected onto the sensor through a mask equipped with a rectangular window, whereby the shaded surface permits an evaluation of the angle of incidence in two orthogonal coordinate directions in relation to the illuminated surface of the sensor. It has been found to be a drawback of this system that it is mainly the large area of the window that causes substantial falsifications in the determination of the angle due to sources of interfering light.

U.S. Pat. No. 4,874,937 discloses a digital sun sensor in connection with which a slotted shutter is arranged located above a linear sensor array (CCD) at a right angle in relation to the longitudinal expanse of the array. The spacing of the slotted shutter from the sensor array is preset in this connection by an optical prism with plane parallel faces. The sunlight falls into the slotted shutter at a defined angle and is uniformly diffracted. In this way, the sunlight strikes a defined group of sensor elements. Based on the sensors struck, an electronic circuit determines the maximum sunlight by a special type of pulse sequence resolution, and calculates the angle of incidence.

Another sun sensor in the form of a slot or perforated shutter sensor for a satellite has been published in U.S. Pat. No. 5,698,842. The sensor has a particularly thick (2.5 to 10 mm) slotted shutter with a very narrow slot (about 0.1 mm). Large angles of incidence of the sunlight are obtained by suitable selection of the spacing of the shutter above the linear sensor array. As with all the other digital sun sensors, the expenditure required for the evaluation electronics is very high in the present case as well, due to the use of CCD's.

An analog sun sensor is known from U.S. Pat. No. 5,572,316 in connection with which a slot that is very narrow as well, is laterally projected onto a long-stretching rectangular area that includes two separate triangular photodiode surfaces. When the reproduction of the slot is displaced, the proportions of the length of the slot falling to each of the two photodiode surfaces change. The generated photon fluxes thus change in relation to each other in opposite directions as well, so that the difference between the photon fluxes is a measure of the angle of incidence of the light.

All of the last-mentioned sun sensors have in common that each one has to operate with very narrow slot widths in order to achieve high resolution of the angle of incidence of the light, which highly limits the amount of light incident on the detector array, and can easily falsify the measurement due to interference factors.

The invention addresses the problem of finding a new possibility for determining the angle of incidence of light that assures high measuring accuracy combined with low expenditure for evaluation electronics. Furthermore, the goal is to achieve low susceptibility versus sources of interfering light and other error signals.

### SUMMARY OF THE INVENTION

The invention provides an arrangement for determining the angle of incidence of light. The arrangement includes a long-stretching detector array and a slot for illuminating the sensor array with or by a band of light. The slot is arranged in an orthogonal configuration in relation to a preset longitudinal direction of the detector array, with a defined spacing above the light-sensitive surfaces of the detector array. This spacing mainly presets the maximally detectable angle of incidence of the light. According to the invention the detector array includes a plurality of congruent photodiode areas or surfaces arranged in rows and substantially having the same length and width. The size of each photodiode area is such that upon illumination by the band of light in one photodiode area, a maximum photoelectric current having a minimum amount for the division into digital resolution stages of the desired size and number of photodiode areas is generated. In this arrangement, the photodiode areas are lined up in rows, and the width of the band of light produced by the slot corresponds with their longitudinal expanse. In this way, portions of the light-sensitive photodiode areas overlap one another in the longitudinal direction of the lined-up photodiode array in spite of light-insensitive bridges that are required for electrically insulating neighboring photodiode areas. At least two photodiode areas simultaneously supply at any time from the band of light a significant photoelectric current.

In an advantageous embodiment of the invention, each photodiode area has first parallel edges that are aligned along two straight lines in parallel with the longitudinal direction of the photodiode array, as well as second parallel edges that are substantially different from the orthogonal direction in relation to the first edges, whereby the first and the second parallel edges intersect each other and form corners of a photodiode area that are differently positioned in the longitudinal direction of the photodiode array, in a manner such that when viewed in the longitudinal direction of the photodiode array, the first front edge of a photodiode area is arranged in front of a last rear corner of the preceding photodiode area. The photodiode areas can be arranged in different degrees of overlapping as desired. The first front edge of a photodiode area is usefully located in front of the first rear edge of the preceding photodiode area.

Overlapping of the photodiode area in the longitudinal direction of the photodiode array can be achieved in a particularly advantageous manner if the array of photodiodes is composed of at least two parallel rows of photodiodes. These rows are of the same type, and are arranged offset in relation to one another by a fraction of the center spacing between the photodiode areas. In this way, preceding and succeeding photodiode areas are arranged in an alternating manner in the different rows of photodiode areas, and are equidistantly distributed in the longitudinal direction of the array of photodiodes.

Photodiode areas with non-orthogonal edges are shaped in this connection so that preferably the first front corner of a photodiode area is disposed with respect to the longitudinal direction of the photodiode array in the same position as the second front corner of the preceding photodiode area. In this way, no signal jumps occur as the band of light is moving across bridges between the photodiode areas.

To achieve the overlap between the photodiode areas struck by the light beam, different shapes of quadrangles having straight edges can be used. The photodiode areas may be trapezoidal, with the trapezoids aligned, and each trapezoid within the linear photodiode array turned by 180° in relation to an adjacent trapezoid. Furthermore, the photodiode areas advantageously may be parallelograms, whereby the parallelograms each are aligned with a parallel pair of edges parallel in relation to the longitudinal direction of the photodiode array. Rhombi are preferably selected as photodiode areas.

Another possibility for shaping the photodiode areas is to provide them with the shape of congruent, stylized arrowheads, whereby such arrowheads have first parallel edges in the longitudinal direction of the photodiode array, as well as angled second parallel edges.

If a photodiode array with several rows is employed, the photodiode areas may be rectangles as well, preferably squares, whereby it should be assumed in particular in connection with this embodiment that the light beam is a relatively wide beam of light with a Gaussian intensity profile. The width of the slot is usefully selected so that the band of light reproduced on the photodiode array has the order of magnitude of the longitudinal expanse of a photodiode area. For evaluating the position of the light beam and thus for determining the angle of incidence of the light, photoelectric currents, i.e. the electrical signals produced, are used advantageously only from those photodiode areas that are successively arranged in the longitudinal direction of the photodiode array and (in an uninterrupted manner) have a signal level above a defined noise level. The center of gravity of the photoelectric currents is then determined using the photodiode area of the photodiode array that has the highest photoelectric current of the photodiode array. The position of the line of concentration of the band of light is determined based on a preselected number of photodiode areas located within the vicinity of the photodiode area having the highest photoelectric current.

When a single-row photodiode array is employed, the number of photodiode areas used for calculating the center of gravity is advantageously limited to three areas. For a two-row photodiode array, the number of photodiode areas used for calculating the center of gravity is limited to five of such areas.

If several parallel rows of photodiode areas are employed, it is advantageous if the rows of photodiodes can be evaluated separately from each other as well. In that case, the rows function as redundant, single-row photodiode arrays. However, for higher accuracy of the angle resolution, multi-row photodiode arrays are advantageously evaluated jointly. In so doing, the measured values of the photoelectric currents of the individual photodiode areas have to be combined or merged (“mated”, if necessary) in the sequence of their positions along the longitudinal direction of the photodiode arrays. For determining the angle of incidence of light in two three-dimensional angle coordinates, two separately evaluated photodiode arrays of the same type are usefully arranged on a detector chip with an orthogonal configuration in relation to each other. Separate slots for producing the band of light, are associated with each of the two photodiode arrays. The slots are disposed on a common shutter plate with an orthogonal configuration in relation to each other as well. The detector chip and the shutter plate are in this connection advantageously produced by means of the same technology, so that only their mutual alignment will still influence the accuracy of the photodiode arrays at both solid angles, and adjustment errors will be minimized. For the determination of the angle of incidence of sunlight, at least one additional individual sensor, namely a sun presence detector, is advantageously available for detecting the presence of sunlight on the detector chip. For the purpose of increasing the measuring accuracy of the photodiode arrays, at least one additional individual detector may be provided on the detector chip, such additional detector having been produced by the same technology and with the same surface size as the photodiodes of the arrays arranged in rows, and being covered in a manner such that it is opaque, for the purpose of detecting the dark current on the detector chip.

Fundamentally, the invention recognizes the need, in an arrangement for determining the angle of incidence of light by reproducing a slot on a linear array of detectors, to reduce the electronics cost without reducing the necessary high resolution of the band of light position reproduced by the slot. A photodiode array with less sensitivity is preferred for that reason over CCD-lines. The drawback of accepting lesser sensitivity is compensated by the embodiment of linear photodiode arrays as defined by the invention in that the surfaces or areas of the photodiode arrays are designed adequately large for obtaining a sufficiently high photoelectric current by illuminating such photodiode arrays with the band of light. The reduced resolution of the position of the band of light that accompanies the large expanse of the photodiode areas, is balanced by receiving the photoelectric current in the form of analog signals, as well as by a “bridging” of the bridges between the photodiode areas, such bridges being required for the purpose of electronic insulation. This measure for avoiding signal failure on the bridges between the photodiode areas is accomplished according to the invention by overlapping parts of neighboring photodiode areas, so that at least two photodiode areas simultaneously supply a significant photoelectric current with the band of light being in any position. This can be obtained by special shapes of the areas that permit bridges extending non-orthogonally relative to the longitudinal direction of the arrays of photodiodes, and/or through several parallel rows of photodiodes that have concentrations of the photodiode areas that are offset against one another. Avoiding signal failure on the bridges is especially important for the evaluation of the analog signals. signal jumps of the photoelectric currents should be excluded as completely as possible and signal evaluation should be kept simple. In this way, problems of overcontrolling and surge evaluation of the noise of the photodiodes are reduced and thus errors in the signal evaluation are minimized.

The arrangement as defined by the invention permits determining the angle of incidence of light through the use of arrays of photodiodes with reduced expenditure for evaluation electronics while securing high accuracy at the same time. Furthermore, a relatively large width of the slot, such width being adapted to the longitudinal expanse of the photodiode areas, is permissible. Combined with a simple evaluation algorithm, such large width of the slot additionally assures lower susceptibility vis-a-vis interfering light. In addition, it is possible to advantageously realize the invention in the form of an analog sun sensor manufactured in a photolithographic production process with orthogonal rows of arrays of photodiodes located on a common chip, and to adjust and calibrate such a sensor with a uniform slot shutter mask that can be produced by photolithographic production methods as well.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a basic representation of the arrangement as defined by the invention shown by a top view and a sectional side view.

FIG. 2 shows a design of a line of photodiodes as defined by the invention, with photodiode areas in the form of parallelograms.

FIG. 3 shows an embodiment of a photodiode array in accordance with the invention, which includes parallelograms as photodiode areas.

FIG. 4 shows a two-row variation of an array of photodiodes as defined by the invention.

FIG. 5 shows a three-row arrangement with different orientations of the rows with diamond-shaped photodiode areas.

FIG. 6 shows an embodiment of the photodiode areas shaped in the form of stylized arrowheads.

FIG. 7 shows an embodiment of the photodiode areas in the form of a row of oppositely oriented trapezoids.

FIG. 8 shows a two-row arrangement of rectangular photodiode areas with displaced area concentrations; and

FIG. 9 shows a sectional view of an advantageous embodiment of a detector chip serving as a sun sensor.

### DETAILED DESCRIPTION OF PREFERRED EMBODIMENTS

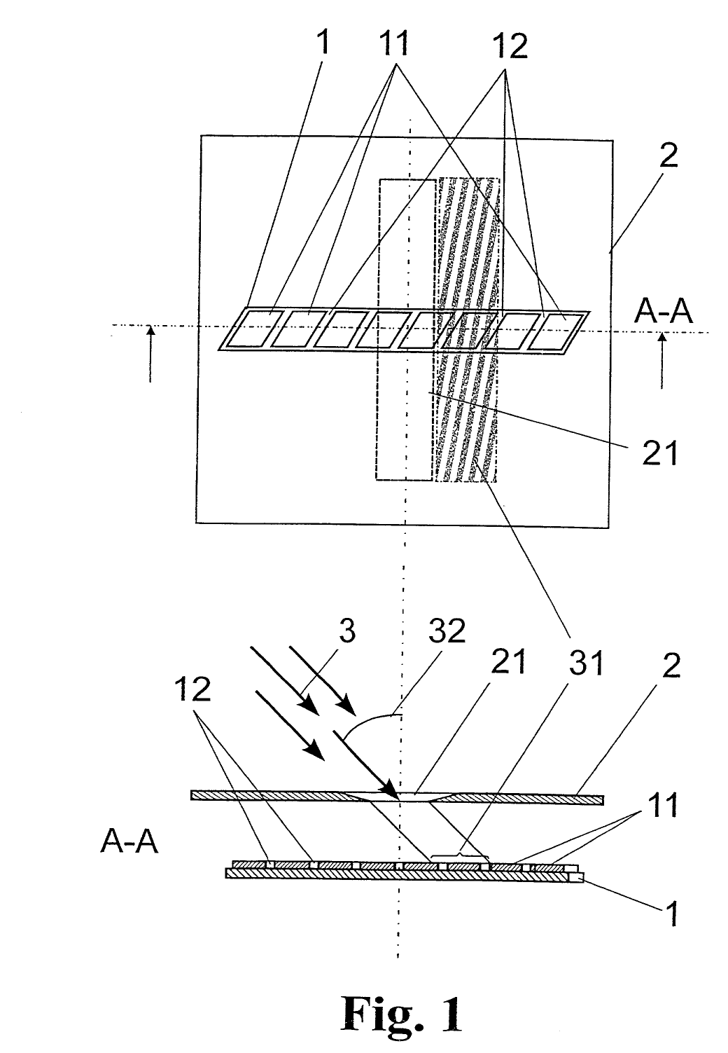

FIG. 1 shows the basic structure of the arrangement for determining an angle of incidence of light as defined by the invention. The arrangement includes a sensor or photodiode array 1 having a substantially linear expanse, and a shutter plate 2. The array includes a plurality of photodiode areas 11. Shutter plate 2 is mounted with a defined spacing above photodiode array 1 and has a slot 21. The slot permits a substantially parallel light beam 3 to pass through, in order to determine the angle of incidence 32 of the light. As shown by the upper top view in FIG. 1, slot 21 is aligned orthogonally to the longitudinal expanse of the photodiode array 1 and crosses the center of photodiode array 1. The light passing through slot 21 produces a light pencil 31 illuminating photodiode array 1 transversely to the longitudinal expanse of the array. The band of light illuminates different photodiode areas 11 depending on the angle of incidence 32 of light beam 3. The position of light pencil 31 is determined by evaluating the photoelectric currents of the photodiode array. This position is a measure of the angle of incidence 32 of the light beam 3. According to the invention, the individual detector elements of photodiode array 1 are the relatively large photodiode areas 11. Bridges 12 are located between photodiode areas 11. These bridges are required to electrically insulate photodiode areas 11 so that cross-talk or inductive disturbance is prevented to a large extent. The bridges are arranged so that with the light pencil 31 being in any position, at least two neighboring photodiode areas 11 simultaneously supply a significant photoelectric current. This means, on the one hand, that the light pencil 31 incident on photodiode array 1 has to be wide enough to continuously illuminate a substantial part of at least two photodiode areas 11. Hence, a relatively wide slot 21 is used as compared to the slot used in CCD-line sensors to determine the angle of incidence of light. The dimensions of the photodiode areas are also substantial for this purpose as well. The dimensions of the photodiode areas have be clearly larger than sensor elements in a CCD sensor array in view of the significantly lesser sensitivity (versus CCD) of the photodiodes. The larger dimensions are needed in order to generate photoelectric currents that have an adequate signal/noise ratio. On the other hand, in accordance with the invention, the arrangement of the photodiode and the width of the slot enables the simultaneous illumination of a plurality of photodiodes. The light sensitive areas have portions which overlap each other in the direction of the longitudinal expanse of photodiode array 1. In other words, these portions have overlapping longitudinal positions in the array. FIG. 1 shows a first embodiment for obtaining this overlapping. The photodiode areas 11 are separated from one another by nonorthogonal bridges 12. It is also important in this overlapping arrangement to evaluate photodiode areas 11 by analog measurement of the photoelectric currents. To calculate the angle of incidence of the light, it is important to determine the position of the center and the line of centers of gravity 311 of the intensity profile of light pencil 31. This determination is important to achieve the accuracy conventional sensors have in determining the angle of incidence of light despite the substantially greater dimensions of the photodiode areas 11 in the arrangement according to the invention.

The lower portion of FIG. 1 is a sectional representation along line A-A of the top view shown at the upper portion of FIG. 1. This section view shows shutter plate 2 arranged with a defined spacing above photodiode areas 11. This spacing, along with the maximum angle of incidence 32 selected (for example ≧±64° with a sun sensor), has a substantial influence on the degree of the change occurring in the position of light pencil 31 which depends on angle of incidence 32. Thus, the spacing influences the angle resolution of the arrangement as defined by the invention.

In the lower sectional drawing of FIG. 1, slot 21 is shown in a stylized form with wedge-shaped edges whose geometric shape permits unrestricted passage of light beam 3 and also accommodates large angles of incidence. The sharp-edged border of slot shutter 2 on slot 21, is in practice produced using an opaque coating on the underside of a transparent carrier plate. Slot 21 is produced by microlithographic techniques. FIGS. 2 to 8 and the associated parts of the specification which follow show and describe further variations and contain more detailed descriptions of the shape of photodiode areas 11 and bridges 12.

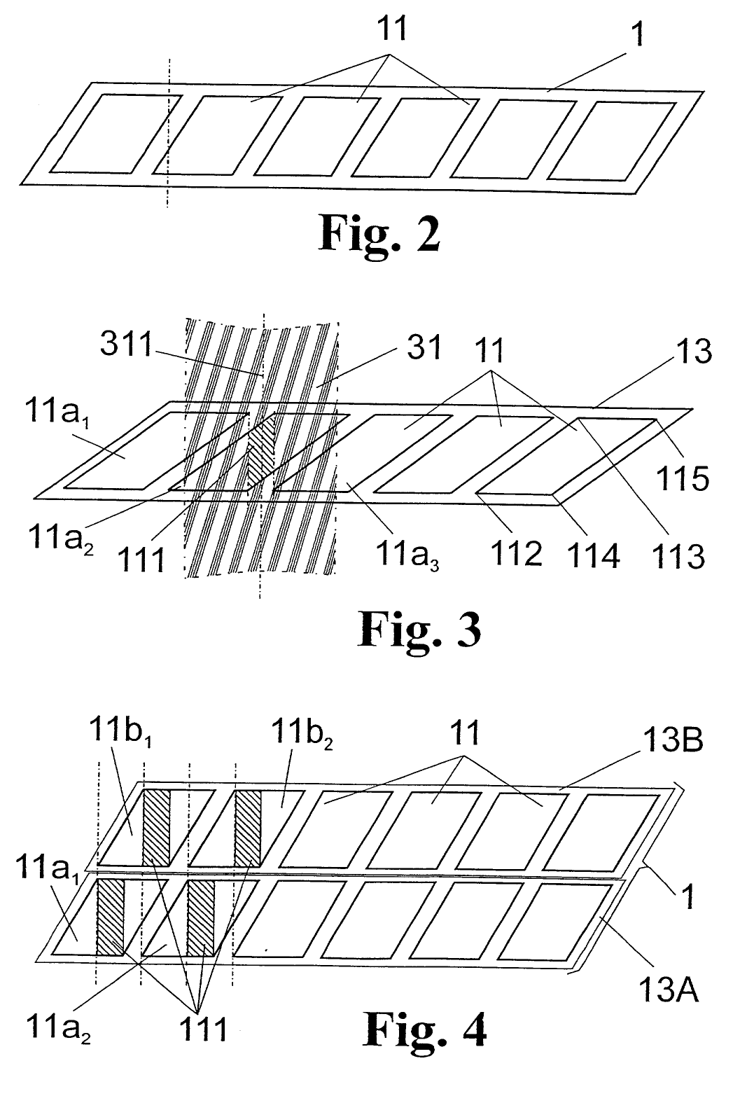

FIGS. 2 and 3 show a single-row photodiode array 1 having photodiode areas 11 in the form of parallelograms, similar to those shown in stylized form in FIG. 1. The array includes portions of neighboring photodiode areas 11 that overlap each other as indicated by the vertical line in FIG. 2. The parallelograms are congruent and mounted on a common substrate so that each photodiode area 11 has a pair of edges lined up with the other photodiode areas along two parallel straight lines. The orthogonal dash-dotted line symbolizes line of centers of gravity 311 shown in FIG. 3 of light pencil 31. As indicated in FIG. 1, the light pencil 31 is more of a rectangular area than a one-dimensional line. The width of light pencil 31 should be slightly greater than the maximal longitudinal expanse of a photodiode area 11. In this way, resolution of significant photoelectric currents in a plurality of photodiode areas 11 is ensured. With the configuration of photodiode areas 11 shown in FIGS. 2 and 3, most random positions of light pencil 31 will cause three photodiode areas 11 to generate a photoelectric current above a selected threshold noise level.

In FIG. 3, each parallelogram has two front corners 112, 113 and two rear corners 114, 115 viewed left to right in the longitudinal direction of the array. The parallelograms of photodiode areas 11 have a stretched shape. Viewed in the direction of the longitudinal expanse of photodiode array 1, the first front corner 112 of a photodiode area, for example photodiode area 11a₃, is located at the same level or longitudinal position as the second front corner 113 of the preceding photodiode area 11a₂ as indicated by the vertical line connecting these corners in FIG. 3. The intensity function of light pencil 31 is not a rectangular function but almost a Gaussian distribution and overlaps with the functional area of the parallelogram. Due to this overlap resulting from the configuration shown in FIG. 3, when photodiode area 11a₂ is primarily illuminated and triggers a maximum photoelectric current, a measurable photoelectric current will be available from both the preceding photodiode area 11a₁ and from the succeeding photodiode area 11a₃. As light beam 31 continuously shifts to the right in the direction of the longitudinal expanse of photodiode arrays 1, and line of centers of gravity 311 of light pencil 31 sweeps the shaded area ill, almost no change occurs in the photoelectric current of the primarily illuminated photodiode area 11a₂ because line of centers of gravity 311 passes through an area 111 in which the parallelogram has a constant width. However, in the preceding photodiode area 11a₁, the same shifting of light pencil 31 to the right has a very distinct intensity-diminishing effect. The portion of photodiode area 11a₁ that is illuminated diminishes quickly due to the slanted edge between the rear corners 114 and 115 of the photodiode area 11a₁. Hence, the illuminated part of the photodiode area 11a₁ (and thus its photoelectric current) is reduced much quicker than otherwise would have occurred from the differential displacement of light pencil 31 had the edge not been slanted. The same effect, though with a reversed sign, occurs in the primarily illuminated photodiode area 11a₃ following the photodiode area 11a₂. In this area, the ascending front edge causes a rapid gain in the photoelectric current between the two front corners 112 and 113 because the effective height of the photodiode area 11a₃ also grows simultaneously with the continuous shift of light pencil 31. In this arrangement, light pencil may be made slightly narrower than in FIG. 1, where the width of light pencil 31 was made slightly larger than the longitudinal expanse of photodiode areas 11. In FIG. 3, due to the configuration of photodiode areas 11, a greater overlap of photodiode areas 11 exists. Hence, significant photoelectric currents will still be obtained simultaneously in several photodiode areas 11 at all times even with a slightly narrower light pencil. This circumstance occurs even more distinctly in connection with a two-row photodiode array 1 according to FIG. 4. The array has two rows 13A and 13B of parallelogram-shaped photodiode areas 11. Each photodiode area has first and second front corners as designated in FIG. 3 connected by an ascending edge from left to right. Here, the two rows 13A and 13B are arranged so that each area 111 of the parallelogram-shaped photodiode areas 11 having a constant width (indicated by shading) is overlapped by the ascending edge between the first and second front corners 112 and 113, respectively, of the next photodiode area 11. In the specific embodiment of FIG. 4, this arrangement results in having the second front corner 113 of the first photodiode area 11a₁ of the photodiode row 13A disposed along the longitudinal direction of the photodiode array 1 at the same longitudinal position as the first front corner 112 of the first photodiode area 11b₁ of the second photodiode row 13B as indicated by the left most vertical line in FIG. 4. The second front corner 113 of the first photodiode area 11b₁ of the second photodiode row 13B then in turn “coincides” with the first front corner 112 of the second photodiode area 11a₂ of the first photodiode row 13A as indicated by the next vertical line in FIG. 4. Therefore, once line of centers of gravity 311 of the light pencil 31 (not shown) has reached the second front corner 113 of photodiode area 11a₂, it also reaches at the same time the longitudinal position or level of the first front corner 112 of the second photodiode area 11b₂ of photodiode row 13B. This means that when the photoelectric current in the first photodiode area 11a₁ has reached its maximum and no longer changes for the time being due to the constant width of the area (area 111), the photoelectric current in the second photodiode area 11b₁ rises distinctly. Once the photoelectric current maximum has been reached in the photodiode area 11b₁, the photoelectric current in the next photodiode area 11a₂ changes. When photodiode area 11a₂ discharges its maximum photoelectric current, the photoelectric current in the fourth photodiode area 11b₂ starts to rise significantly. An opposite behavior of the photoelectric currents emerges in an analogous manner on the rear edges between corners 114 and 115 of photodiode areas 11. This results in a photoelectric current (as an analog measurement value that can be subsequently converted into digital stages of a defined quantity) that significantly rises or decreases in at least one photodiode 11 at any point along the path of light pencil 31 in the longitudinal direction of photodiode array 11. In this way, line of centers of gravity 311 of light pencil 31 can be determined in a very precise manner. The photoelectric currents of a “packet” of significant photoelectric currents of successive photodiode areas 11 can be evaluated, and the accuracy and reliability of the determination of the position are consequently distinctly increased. In the embodiment of FIG. 4, the successive photodiode areas 11 alternate between photodiode rows 13A and 13B. In addition, by conducting a “packet evaluation” exclusively from photodiode areas 11 that successively have adequately intense photoelectric currents, it is also possible to sort out in a simple manner interference light reflexes and the like that would otherwise falsify the calculation of the position of light pencil 31.

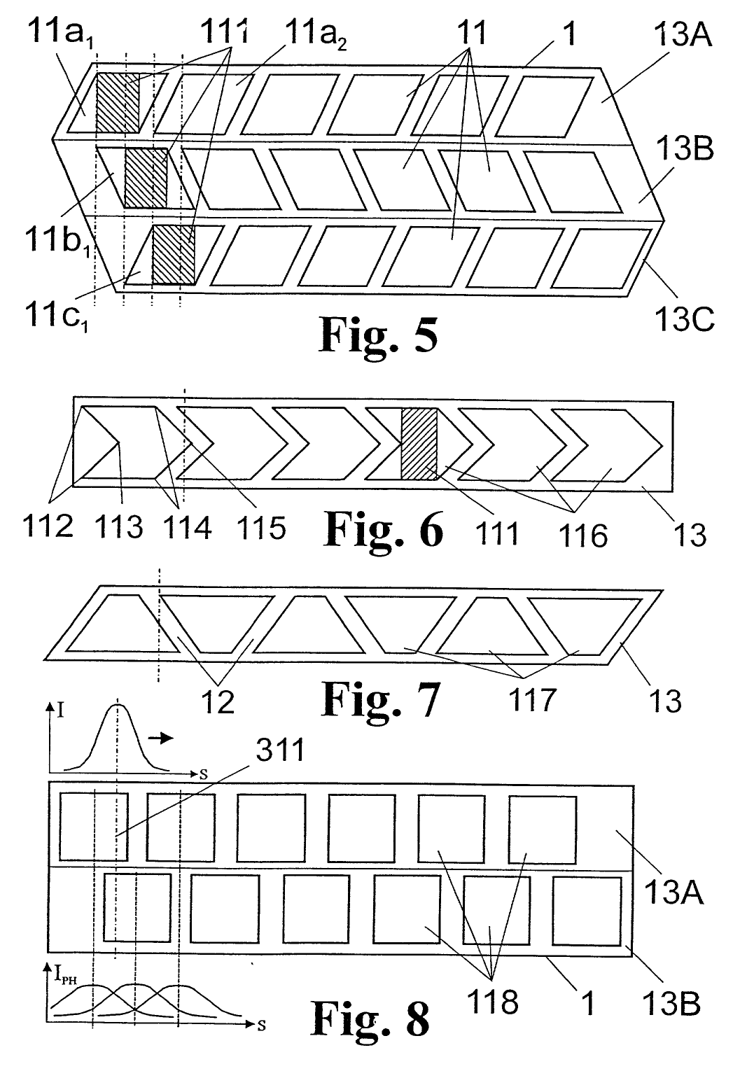

FIG. 5 shows a three-row embodiment of photodiode area 1, which is a variation of the FIG. 4 embodiment. In this embodiment, rhombic photodiode areas 11 are used and are disposed so that the slanted edges of photodiode areas in photodiode row 13B are in a different direction from the slanted edges of photodiode areas in the neighboring rows 13A and 13C. The degree of inclination of the slanted edge between the first and second front corners 112 and 113, respectively, is the same for all rhombuses and solely dependent upon the length of the edge of the rhombuses and on the number of the photodiode rows 13 which is three in FIG. 5. However, the position of the inclined edges is determined according to the same consideration as in the embodiment of FIG. 4. Notably, the first front edge 112 of the photodiode area 11b₁ (top left corner of photodiode area 11b₁) is located at the same level as the second front edge 113 of the photodiode area 11a₁. The first front corner of photodiode area 11c₁ “coincides” with the second front corner 113 of the photodiode area 11b₁ (lower left corner of photodiode area 11b₁). The second front corner 113 of the photodiode area 11c₁ of the third photodiode row 13C and the first front corner 112 of the next photodiode area 11a₂ located in the first photodiode row 13A are then located again in the same line (third dash-dotted line from the left). Furthermore, as shown in the stylized representation of FIG. 5, it is possible to mount all of the photodiode rows 13A to 13C on one chip. In so doing, a small inclination of the slanted edges of photodiode areas 11 has a positive effect. This effect arises because the areas 111 of the photodiodes with the same width (and thus having an almost constant photoelectric current) are each overlapped by the slanted front edges of two successive photodiode areas. For example, area 111 of photodiode 11a₁ is overlapped longitudinally by a portion of the front slanted edges of photodiode area 11b₁ and 11c₁. Therefore, an exact computation of light pencil 31 is possible even where a preliminary illuminated photodiode area 11 over the length of area 111 has reached its maximum photoelectric current. In such circumstances, even when line of centers of gravity 311 of light pencil 31 is in a position where an exact determination of the light beam 31 would not be possible, neighboring photodiode areas 11 will be available to supply a significant, sensitively locally dependent photoelectric current that permits an exact computation of light pencil 31.

FIGS. 6 and 7 show further embodiments for photodiode rows 13, which can be employed both as single-and multi-row photodiode arrays 1.

FIG. 6 represents a variation of the shape selected for photodiode surfaces 11 that has particularly high local dependence of the photoelectric currents. In this embodiment, the equally wide zones 111 of the photodiode surfaces 11 can be made with a small size in a particularly simple manner. Photodiode areas 11 take the form of stylized arrowheads 116. The arrowheads have first front corners 112 and first rear corners 114, with parallel edges located between the front and rear corners. The parallel edges are aligned parallel with the longitudinal direction of photodiode row 13. Edges angled in a simple manner are present between each of the two first front corners 112 as well as also between the two first rear corners 114, the edges in turn being aligned in parallel and forming at their intersection, i.e. where the edges bend, the second front corner 113 and the second rear corner 115, respectively, of arrowhead-shaped area 116. As line of centers of gravity 311 of light pencil 31 (not shown in this figure) moves across the area of the angled edges located between the first rear corners 114 of an arrowhead-shaped surface 116 and the second front corner 113 of the succeeding arrow-head-shaped surface 116, a highly sensitive change of the photoelectric current occurs in both arrowhead-shaped areas 116. In addition, only a minor reduction in the total photoelectric current will become noticeable within the area of bridge 12 separating the two areas. With this embodiment, the area 111 having the same width as the arrowhead-shaped surface 116 can be kept as short as possible and to almost any desired extent in order to keep the insensitive proportions of photodiode row 13 as small as possible. However, photodiode row 13 can also be sensitized by using a second displaced photodiode row 13 and arranging successive arrowheads 116 following each other in the photodiode array 1 so that they alternate in different photodiode rows 13. This arrangement is analogous to the procedure used in connection with the parallelogrammatic or rhombic shape of the photodiode surfaces 11.

FIG. 7 represents an embodiment where photodiode surfaces 11 take the form of trapezoids, which is equivalent to the parallelogrammatic shape. Unlike the case with parallelograms, the bridges 12 are not equally aligned and parallel. Rather, the bridges and therefore the trapezoids alternate in opposite directions versus the orthogonal in relation to the longitudinal direction of the photodiode row 13. With the trapezoids 117, the principle of overlapping of photodiode surfaces 11 remains completely identical to that specified above in regard to FIGS. 2 to 4 as far as the type, measure and inclined position of the bridges 12 are concerned.

A substantially modified embodiment of the invention is shown in FIG. 8. This embodiment is exclusively applicable to photodiode arrays having a plurality of rows. A two-row photodiode array 1 was used in the present case for the sake of simplicity for explaining FIG. 8. As opposed to all other embodiments described above, photodiode array 1 is produced in this case as rectangular, and specifically square-shaped, photodiode surfaces 118 as is preferred. In a two-row photodiode array 1, the square-shaped photodiode areas are arranged so that the centers of concentration of photosensitive rectangular surfaces 118 are each located in the photodiode rows 13A and 13B in an alternating manner. The center of gravity of each rectangular surface 118 in row 13B is disposed at the same level as the center of a bridge 12 located in the photodiode row 13A. With photodiode surfaces 111 in the form of rectangular surfaces 118 as arranged in FIG. 8, an increase in surface area does not result in an additional rise in the photoelectric current when the position of the light pencil 31 is shifted; however, the principle of the invention functions nonetheless because of the actual, nonrectangular intensity profile of light pencil 31. This intensity profile is schematically shown in FIG. 8 above the two-row photodiode array 1. The intensity profile approximately corresponds with a Gaussian bell curve. The intensity function of light pencil 31 overlaps with the surface function of rectangular surfaces 118 in a manner very similar to the above non-orthogonal configurations of photodiode surfaces 11. This arrangement results in only a minor signal drop within the vicinity of bridges 12, as well as in a flattened curve of the function of the photoelectric currents in dependence on the location “s” of line of centers of gravity 311 of light pencil 31 versus the intensity profile of light pencil 31. The facts of the case are shown in FIG. 8 by schematic graphics below photodiode array 1 shown in the figure. The graphic representation shows the photoelectric currents IPH associated (dashed lines) with the surface centers of concentration of the first three successive rectangular surfaces 118 as a function of the location “s” along photodiode array 1. The measured values of the photoelectric currents originating from the photodiode rows 13A and 13B merge in an alternating manner. In other words, the peak of photoelectric current of a photodiode area in one row will coincide with a low photoelectric current from an adjacent photodiode area in the other row.

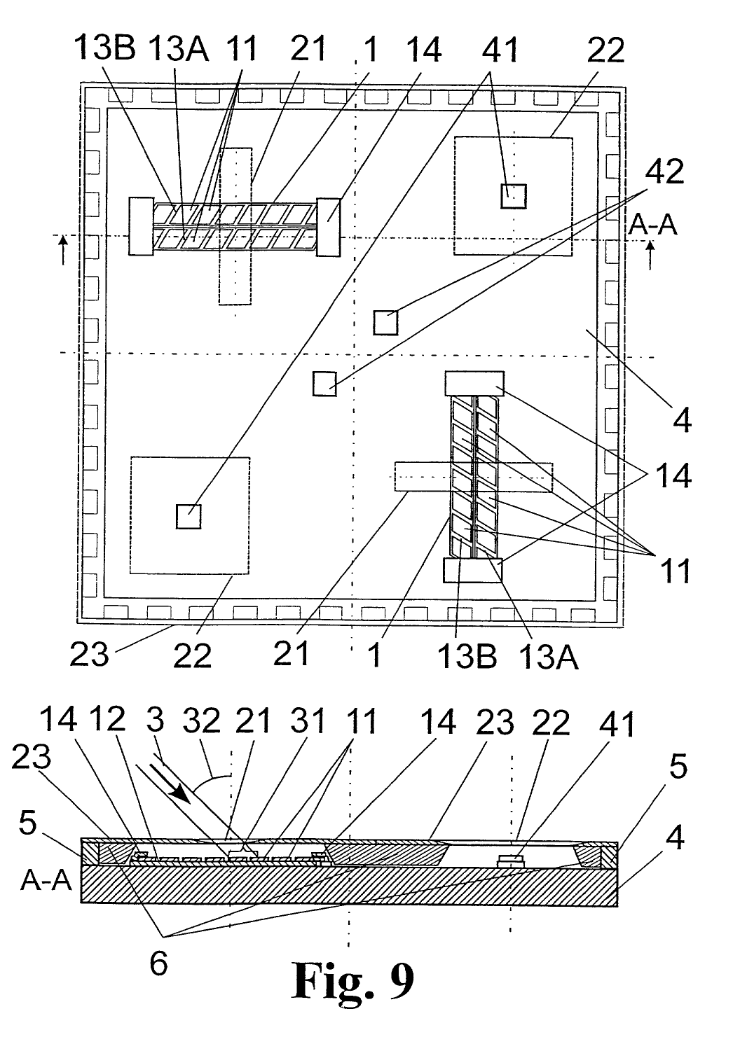

The application of the invention in a fully functional sun sensor is shown in FIG. 9 and explained in the following. It is assumed in connection with this embodiment without limiting the generality that the direction of the light incident on a sun sensor should generally be in two angle coordinates of space, notably separately and independently of one another.

As shown in FIG. 9, two separate arrays as defined by the invention are mounted for this purpose on one common chip 4 in an orthogonal configuration in relation to each other. A uniform photolitho-process preferably is used to produce this arrangement. This process achieves particularly high accuracy in setting forth the relative positions of the individual photodiode arrays 1. In this way, any adjustment of the two photodiode arrays 1 in relation to one another can be dispensed with when the sun sensor is installed. Furthermore, if the slot 21 for the two separate photodiode arrays 1 is produced in a common shutter plate 23 by means of photolithographical techniques, the dimensions and positions of slots 21 may be adjusted with high precision with respect to each other as well. In this way, only common shutter plate 23 needs to be adjusted vis-à-vis common chip 4.

Chip 4, which preferably has a square base surface, is divided in four quadrants, whereby the two photodiode arrays 1 are arranged in the second and fourth quadrants so that they coincide with each other if rotated by 90° around the center of chip 4. Additional detectors are arranged in the first and third quadrants of chip 4 in order to make the flawless operation of the sun sensor complete. The additional detectors include a sun presence detector 41 which detects the presence of sunlight, and a dark-current detector 42 in each of these quadrants. Their arrangement in pairs solely serves the purpose of redundancy. Dark current detector 42 is made by the same manufacturing process and corresponds with each of the photodiode surfaces 11 in the photodiode arrays 1 with respect to its layered structure and its content of surface area. Detector 42 is completely darkened by a metallic coating that is directly applied to the photosensitive surface. Exclusion of light is ensured by additionally covering the detector shutter plate 23, which is completely enclosed in the site. The dark current detectors 42 are therefore arranged close to the center of chip 4. The two redundant sun presence detectors 41 detect whether or not sunlight is present to begin the evaluation of the photodiode arrays 1. The detectors are placed diametrically opposite to each other in the first and third quadrants of chip 4, and specifically as far as possible on the outer side. Each detector 41 requires a large window 22 in common shutter plate 23. With this arrangement, the other detectors, namely the photodiode arrays 1 and dark current detectors 42, cannot be influenced by scattered light even in the least favorable case. Sun presence detector 41 preferably has a square surface, but in any case has the same surface area as each photodiode surface 11. Sun presence detector 41 requires a window 22 of a substantial size in common shutter plate 23 for securing a large angle of incidence 32 of sunlight, i.e. a size as specified for the measuring photodiode arrays 1 (assumed to amount to ±64° in the present case). The size is such that the incident light is safely separated from the light openings (slot 21) of the photodiode arrays 1 by a separation (or partition) disk 6. This disk is shown in FIG. 9 in the lower sectional representation. In this way, separating disk 6 creates for each of the detectors (two photodiode arrays 1 and two sun presence detectors 41) separate bays of light that prevent the detectors from influencing each other (also versus the dark current detectors 42).

Photodiode arrays 1 located in the second and fourth quadrants of chip 4 each take the form of two rows. The photodiode rows 13A and 13B are arranged in exactly the same manner as already described above in connection with FIG. 4. The first and the last parallelogram-shaped photodiode surfaces 11 are covered by a cover layer 14 that is applied by a photolithographical method as well. The cover layer is applied orthogonally in relation to the longitudinal expanse of photodiode array 1. The first and last surfaces are covered to an extent such that in the presence of the maximally permissible angle of incidence 32 of light beam 3 entering through slot 21, light pencil 31 will reach up to cover layer 14.

This partial shading of the start and end surfaces makes sense for two reasons. First, the photolithographic production of the completely congruent photodiode areas 11 (including the starting and the end zones) offers the advantage that all photodiode surfaces 11 nearly have the same dark current. In this way, the surfaces need not be additionally and separately corrected for each element of the photodiode rows 13A and 13B which simplifies the evaluation electronics. Second, cover layer 14 prevents any possibility that in the presence of small angles of light incidence 32, the surface areas of the outer photodiode areas 11 that are actually not illuminated by light pencil 31, might erroneously generate an intensified photoelectric current due to multiple reflections or scattered light. The “field of view” i.e. the maximum angle of incidence 32 of light beam 3, is determined for each photodiode array 1 from the distance between the light-sensitive surface of photodiode areas 11 and slot 21, i.e. the coated underside of common shutter plate 23. A precisely dimensioned spacer element 5 is present for that reason in the form of a frame or ring located in the marginal area of chip 4 of the sun sensor. This frame or ring extends around the entirety of detectors 1, 41 and 42. The spacing element may include additional points of support within the center area of chip 4 for stabilization purposes. By increasing the height of spacing element 5, it is possible to increase the accuracy of the resolution of the angle of incidence 32, which, however, will reduce the “field of view” of photodiode arrays 1.

With the help of slot 21, an adequately wide light pencil 31 (having a width that is just slightly larger than the complete longitudinal expanse of a photodiode area 11, as shown in FIG. 1) is reproduced on photodiode array 1. With the selected structure of photodiode arrays 1, (namely, the double row of parallelogram-shaped elements), light pencil 31 generates in a limited number of photodiode areas 11 photoelectric currents having different intensities. When the position of the light pencil 31 changes, the photoelectric currents change continually and significantly and, with suitable selection of the evaluation algorithm, permit a very exact inference with respect to the position of light pencil 31. Within one photodiode row 13, the number of photodiode areas 11 is kept low, for example, eight in the present case. Keeping the number low permits the use of very simple signal processing electronics. Nevertheless, the structure of photodiode arrays 1 assures adequately high accuracy in determining the position of light pencil 31 and consequently in determining the angle of incidence 32 of a light beam 3 incident from the sun. As light pencil 31 moves across photodiode array 1 in the longitudinal direction, a constant curve (without signal jumps) of the photoelectric currents of the photodiode areas 11 results from the structure of photodiode array 1. The curve of the photoelectric currents is equal to a Gaussian bell curve. This curve, with compensation of the dark currents (by means of the comparative currents of the dark current diodes 42), permits the application of a center of gravity algorithm. In the evaluation of the photoelectric currents of the two photodiode rows 13A and 13B, the angle of incidence 32 (denoted by “α” in the following equations) accordingly follows as

$${α}_{AB} - arctan ( \frac{{\sum }_{i = 1}^{k} {f}_{ai} \cdot {s}_{ai} + {\sum }_{j = 1}^{k} {f}_{bi} \cdot {s}_{bj}}{h \cdot ( {\sum }_{i = 1}^{k} {f}_{ai} + {\sum }_{j = 1}^{k} {f}_{bj} )} ) , \qquad ( 1 )$$

where “k” is the number of photodiode areas 11 per photodiode row 13. In the present example, k=8. The functional values fₐ₁ and f_{bj} represent the measured photoelectric currents IPH and sₐᵢ, and s_{by} represents the spacing of the concentration of the individual photodiode areas 11 of photodiode rows 13A and 13B, respectively. However, the voltage or other measurement signals of photodiode areas 11 that are proportional to the photoelectric current IPH, can be entered for the values fₐᵢ and f_{bj} as well. The factor “h” included in the denominator of the statement of the angular function denotes the distance between photodiode areas 11 and shutter plate 23 (i.e. the actual spacing of slot 21 from photodiode array 1). This distance determines the accuracy of the angle resolution as well as the “field of view” of the sun sensor, as explained previously. Photodiode array 1 can also be operated as a single-row array despite the two-row structure. In other words, either photodiode row 13A or photodiode row 13B is evaluated alone, and the other row 13A or 13B functions as a redundant line array. If only one of the photodiode rows 13A or 13B is to be evaluated for calculating the angle of incidence 32, the equations stated below follow:

$${α}_{A} = arctan ( \frac{{\sum }_{i = 1}^{k} {f}_{ai} \cdot {s}_{ai}}{h \cdot {\sum }_{j = 1}^{k} {f}_{ai}} ) \qquad ( 2 )$$

for the photodiode row 13A, and

$${α}_{B} = arctan ( \frac{{\sum }_{j = 1}^{k} {f}_{bj} \cdot {s}_{bj}}{h \cdot {\sum }_{j = 1}^{k} {f}_{bj}} ) \qquad ( 3 )$$

for photodiode row 13B. Optionally, it is also possible at the same time to independently calculate the position of light pencil 31 based on both photodiode rows 13, and to average the results. The two-row operation of the photodiode arrays 1 provides very high accuracy. The accuracy achievable in the single-row operation is lower, but frequently entirely adequate at least with the special form of the non-orthogonal photodiode surfaces 11 (i.e., the parallelograms in the present example).

The very simple center of gravity algorithm according to equations (1) to (3) is actually reliably applicable only for determining the angle of incidence of light if it is possible to assure, in addition to compensation of the dark current, that photodiode array 1 is impacted by no light source other than the desired one. This is normally not the case in connection with a sun sensor. It is therefore recommended that the algorithm be modified by means of a center of gravity method with a reduced range of light collection. With this method, photodiode area 11 with the maximum photoelectric current is determined first based on the photoelectric currents supplied. Thereafter, the photoelectric currents of at most two neighboring photodiode areas 11 are determined. The photoelectric current of 4 and 5 disposed around the photodiode area 11 with the maximum photoelectric current of array 1 is then subsequently used for determining the position of the center of gravity of light pencil 31. The algorithm can be applied both for the single- and two-row operation of photodiode array 1. The differences are compiled in the overview shown below.

| | One-row | Two-row |
|---|---|---|
| | operation | operation |
| Maximum systematic error at an | ±(6 · 10⁻²)° | ±(5 · 10⁻⁴)° |
| angle range of ±64° | | |
| Maximum systematic error | | |
| at an angle of incidence range | ±0.1° | ±(2.2 · 10⁻³)° |
| of ±64° and a dark-current ratio | | |
| of 10⁻³ without dark current | | |
| compensation | | |
| Number of photodiode areas to be | 2-3 | 4-5 |
| evaluated with limited range of | | |
| light collection | | |

The dark-current ratio specified in the overview shows the amount of dark current in relation to the maximum photoelectric current at full illumination of a photodiode area 11. With the modified center of gravity algorithm with a limited range of light collection, the arrangement in accordance with the invention supplies both high reliability as well as the desired high accuracy. Such high reliability can be increased further by a one-row operation of a two-row photodiode array 1, primarily due to the redundant acquisition of the measured values by photodiode rows 13.

While several embodiments of the present invention have been shown and described, it is to be understood that many changes and modifications may be made thereunto without departing from the spirit and scope of the invention as defined in the appended claims.

What is claimed is:

1. An arrangement for determining the angle of incidence of light from an electrical signal produced by a source of light illuminating a sensor array, which comprises:
(a) an elongated photodiode array extending in a longitudal direction comprising a plurality of photodiode areas having substantially the same length and width arranged in at least one row and separated from each other by light insensitive bridges for electrically insulating adjacent photodiode areas; and
(b) a slot disposed above said photodiode array and orthogonal to the longitudinal direction of said photodiode array for allowing light to illuminate said photodiode array with a band of light having a width defined by said slot, said slot being arranged with a selected spacing above the photodiode areas of said photodiode array to primarily preset a maximally detectable angle of incidence of the band of light;
wherein each photodiode area is dimensioned so that a maximum photoelectric current results when the photodiode area is illuminated by the light pencil, the photoelectric current being sufficient in amount for dividing the current into a selected number of digital resolution stages of a selected size; and
wherein each photodiode area has a length adapted to the width of the light pencil defined by the slot, said plurality of photodiode areas being aligned so that a portion of each photodiode area has a position overlapping a portion of an adjacent photodiode area in the longitudinal direction of said at least one row of photodiodes despite said light insensitive bridges, so that at least two of said photodiode areas simultaneously supply at any position of the light pencil an appreciable photoelectric current from which the angle of incidence of the light may be derived.

2. The arrangement according to claim 1 wherein each photodiode area comprises a first set of first parallel edges aligned with the longitudinal direction of the photodiode array and a second set of second parallel edges aligned nonorthogonally to the first set of parallel edges, each of said first parallel edges intersecting with a corresponding one of said second parallel edges to form a corner of said photodiode area having a different longitudinal position in the photodiode array from another corner so that a first front corner of a photodiode area is located longitudinally along one of the first parallel edges of the first set of parallel edges in front of a last rear corner of a preceding photodiode area located longitudinally along another of the first parallel edges of the first set of parallel edges.

3. The arrangement according to claim 2 wherein the first front corner of a photodiode area is located in front of a first rear corner of a preceding photodiode area located longitudinally along another of the first parallel edges of the first set of parallel edges.

4. The arrangement according to claim 1 wherein the photodiode comprises at least two parallel rows of photodiode areas of the same type equally spaced along the longitudinal direction of the photodiode array, said rows being offset from each other by a portion of the separation between the photodiode areas in each row so that preceding and successive photodiode areas start at different longitudinal positions in each row.

5. The arrangement according to claim 3 wherein the first front corner of a photodiode area coincides longitudinally with a second front corner of a preceding photodiode area located longitudinally along another of the first parallel edges of the first set of parallel edges.

6. The arrangement according to claim 2 wherein the photodiodes areas are in the form of parallelograms, each parallelogram having a parallel pair of edges aligned in parallel with the longitudinal direction of the photodiode array.

7. The arrangement according to claim 6 wherein the photodiode areas are in the form of rhombuses.

8. The arrangement according to claim 2 wherein the photodiode areas are in the form of arrowheads comprising a first set of parallel edges aligned in parallel with the longitudinal direction of the photodiode array and a second set of parallel edges disposed at an angle to said first set of parallel edges.

9. The arrangement according to claim 2 wherein the photodiode areas are in the form of trapezoids, wherein each trapezoid in a row is oriented at 180° with respect to an adjacent trapezoid in the row.

10. The arrangement according to claim 4 wherein the photodiode areas are in the form of rectangles.

11. The arrangement according to claim 4 wherein the photodiode areas are in the form of squares.

12. The arrangement according to claim 1 wherein the width defined by said slot has the same order of magnitude as the length of each photodiode area.

13. The arrangement according to claim 1 wherein a selected number of photodiode areas are uniformly arranged in the longitudinal direction of the photodiode array and only those photodiode areas successively arranged in the longitudinal direction of the photodiode array that generate a photodiode current above a selected threshold level are used to determine the position of a line of centers of gravity of the band of light based on the number of photodiode areas in the vicinity of the photodiode area having the highest photoelectric current.

14. The arrangement according to claim 13 wherein the photodiode areas are arranged in one row and no more than three photodiode areas are used to calculate a center of gravity of the band of light.

15. The arrangement according to claim 13 wherein the photodiode areas are arranged in two rows and no more than five photodiode areas are used to calculate a center of gravity of the band of light.

16. The arrangement according to claim 13 wherein the photodiode areas are arranged in at least three rows, each photodiode row being adapted for evaluation separately from another photodiode row as a single-row photodiode array.

17. The arrangement according to claim 13 wherein the photodiode areas are arranged in at least three rows, at least two of said rows being adapted for joint evaluation whereby the measured values of each photodiode area is evaluated in sequence according to its longitudinal position along the photodiode array.

18. The arrangement according to claim 1 further comprising
(a) a chip mounting said photodiode array and a second photodiode array of the same type as said photodiode array orthogonally in relation to each other; and
(b) a shutter plate arranged above the photodiode arrays comprising the slot for said photodiode array and a second slot associated with the second photodiode array, said slots being disposed orthogonally in relation to each other.

19. The arrangement according to claim 18 wherein the chip comprises at least one additional sensor for detecting the presence of and determining the angle of incidence of sunlight.

20. The arrangement according to claim 18 further comprising at least one dark current sensor arranged on the chip, said dark current sensor being produced by the same technology and having the same surface size as each photodiode area.
